(19) United States
(12) Patent Application Publication
(10) Pub. No.: US 2025/0115709 A1
(43) Pub. Date: Apr. 10, 2025

(54) Polycarbonate Compositions Having a High CTI

(71) Applicant: Covestro Deutschland AG, Leverkusen (DE)

(72) Inventors: Tim Hungerland, Köln (DE); Marius Nolte, Köln (DE); Matthias Knaupp, Langenfeld (DE)

(21) Appl. No.: 18/294,588

(22) PCT Filed: Aug. 1, 2022
(86) PCT No.: PCT/EP2022/071497

§ 371 Date: Feb. 2, 2024

(30) Foreign Application Priority Data
Aug. 4, 2021 (EP) 21189667.5

(51) Int. Cl. C08G 64/06; C08F 114/26; C08K 5/521; C08K 5/5399; C08L 23/06

(52) U.S. Cl. CPC C08G 64/06; C08F 114/26; C08K 5/521; C08K 5/5399; C08L 23/06; C08L 2201/02; C08L 2203/20; C08L 2205/03; C08L 2207/062; C08L 2207/068

(57) ABSTRACT

The present disclosure is directed to thermoplastic compositions on the basis of aromatic polycarbonate having a high comparative tracking index, good flame retardancy and a high heat deflection temperature. The compositions contain a combination of polyethylene, phosphorus-containing flame retardant and fluorine-containing anti-dripping agent. A molding including a region made from the thermoplastic compositions is also disclosed.

### CROSS-REFERENCE TO RELATED APPLICATIONS

This application is the United States national phase of International Application No. PCT/EP2022/071497 filed Aug. 1, 2022, and claims priority to European Patent Application No. 21189667.5 filed Aug. 4, 2021, the disclosures of which are hereby incorporated by reference in their entireties.

### BACKGROUND

### Technical Field

The invention relates to flame-retardant thermoplastic compositions based on polycarbonate having high comparative tracking index.

### Description of Related Art

On account of its high impact strength, high heat distortion resistance and a certain inherent flame retardancy, polycarbonate offers many advantages over other thermoplastic polymers. Due to this unique profile of properties, polycarbonate compositions are suitable for a variety of different applications, for example in the field of electrical and electronic components. In particular, good insulation properties and high flame retardancy are essential safety-relevant basic requirements for materials used in this area. In applications in which the plastic is in direct contact with the electrical conductor paths, a high resistance to tracking currents under voltage load is a prerequisite, in order for there not to be any short circuits within the component and hence a fire.

The comparative tracking index (CTI) describes in general the resistance of a plastics material to environmental influences. The CTI value is a measure of the inclination of a plastic, under environmental influences, such as moisture and soiling, to form under voltage electrically conductive paths on the surface and promote resulting electrical tracking currents. The higher the tracking current resistance or the comparative tracking index (CTI value) of a material, the better suited it is for use in high-voltage applications, for example in modern-day electromobility applications. Another advantage of materials having a high CTI value is the possibility of placing electrical conductor paths in an electronic component closer together without risking a short circuit, which in turn enables the reduction of component dimensions and thus more compact designs and weight savings.

In contrast to other thermoplastic polymers such as polystyrene, polyester, etc., polycarbonate itself has a very low comparative tracking index with moderate flame retardancy. Due to the high proportion of aromatic structures, polycarbonate has a rather high tendency to carbonize. The CTI of pure polycarbonate is about 250 V or even lower (F. Acquasanta et al., Polymer Degradation and Stability, 96 (2011), 2098-2103). However, for numerous applications in the electronics/electricals (EE) sector, for example in the electromobility sector, safety grounds require a high CTI, typically of 600 V (corresponding to insulating material group PLC 0 according to EN 50124), of the materials used. At the same time, the materials must have a high flame retardancy, i.e. a V0 classification according to UL 94V, especially even at thin wall thicknesses.

Although pure polycarbonate typically already has a certain intrinsic flame retardancy (V2 classification according to UL 94 V), this is not sufficient for most applications in the EE sector. In order to achieve the required V0 classification according to UL94V, the addition of suitable flame retardants is required. Typically employed for polycarbonate are halogenated sulfonates (e.g. Rimar salt (potassium perfluorobutanesulfonate, C4 salt) or KSS salt (potassium diphenylsulfone 3-sulfonate)) or also organic phosphates (e.g. bisphenol A bis(diphenyl phosphate) (BDP), resorcinol bis(diphenyl phosphate) (RDP)) or phosphazenes. The mechanism of action of these flame retardants is based on the formation of a solid, carbonized surface layer that interrupts the oxygen supply and thus inhibits the combustion process.

The effect forming the basis for a good comparative tracking index is, inter alia, a low tendency to form conductive paths on the surface. This is in direct contrast to the mechanism of action, the “charring”, of surface-active flame retardants and thus poses a particular challenge in the reconciling of CTI and flame retardancy.

### SUMMARY

The object was therefore that of providing polycarbonate-based compositions that achieve a UL94 V0 classification at 3 mm, preferably at 2 mm, particularly preferably at 1.5 mm, and also have a high CTI of in particular 600 V, preferably determined according to the rapid test method based on IEC 60112:2009. Due to the area of application and the heat development in EE components, the compositions should preferably also have a good heat distortion resistance, in particular a Vicat softening temperature, determined according to ISO 306:2014-3, VST Method B, of at least 110° C.

Surprisingly, it has been found that this is achieved by specific combinations of polycarbonate with polyethylene (PE) in combination with phosphorus-containing flame retardant and with fluorine-containing anti-drip agent.

The invention consequently provides a thermoplastic composition which is free of flame retardants selected from the group of alkali metal, alkaline earth metal or ammonium salts of aliphatic or aromatic sulfonic acid, sulfonamide or sulfonimide derivatives, containing
A) at least 70% by weight of aromatic polycarbonate,
B) >2.0% by weight to 6.0% by weight of polyethylene,
C) 2.5% by weight to <8.0% by weight of phosphorus-containing flame retardant,
D) 0.2% by weight to 2.0% by weight of fluorine-containing anti-drip agent, wherein at least 0.5% by weight of fluorine-containing anti-drip agent is present if the composition contains >4.0% by weight of polyethylene,
   and wherein the % by weight figures are based on the overall composition.

The invention also provides moldings, produced from the thermoplastic compositions according to the invention, i.e. moldings consisting of a thermoplastic composition according to the invention or comprising a region made from a thermoplastic composition according to the invention. Such moldings are in particular those in which the aforementioned profile of properties is particularly attractive, i.e. moldings which are components or parts of components from the EE sector, in particular parts of high-voltage switches, inverters, relays, electronic connectors, electrical connectors, circuit breakers, components for photovoltaic applications, electric motors, heat sinks, chargers and charging plugs for electric vehicles, electrical junction boxes, smart meter housings, miniature circuit breakers, busbars. The component is preferably designed for an operating voltage of at least 400 V. To this end, the material expediently used preferably has a comparative tracking index of at least 600 V, determined as described below in the example section according to the rapid test method based on IEC 60112:2009.

The composition according to the invention may contain, in addition to the components A, B, C, D, further components, for instance further additives in the form of component E. The composition may also contain one or more further thermoplastics not covered by any of the components A to E as blend partners (component F). In the context of the present invention—unless explicitly stated otherwise—the reported % by weight values for the components A, B, C, D and optionally E and also optionally blend partners are each based on the total weight of the composition. It will be appreciated that all of the components present in a composition according to the invention sum to 100% by weight. Where a numerical range has its upper limit indicated by “to X”, this includes the numerical value specified and its upward rounding range.

Thermoplastic polymers that are different from the components A, B and E and are suitable as blend partner include, for example, polystyrene, styrene copolymers, aromatic polyesters such as polyethylene terephthalate (PET) or polybutylene terephthalate (PBT), PET-cyclohexanedimethanol copolymer (PETG), polyethylene naphthalate (PEN), PMMA and PMMA copolymers and also copolymers with styrene such as for example transparent polystyrene-acrylonitrile (PSAN) or thermoplastic polyurethanes. These blend partners are preferably used in concentrations of from 0.5% by weight to 10% by weight.

However, it is very particularly preferable when the above-described compositions do not contain any further components, and instead the amounts of components A, B, C, D and optionally E, in particular in the preferred embodiments described, add up to 100% by weight, i.e. the compositions according to the invention consist of components A, B, C, D, optionally E.

It will be appreciated that the components used may contain typical impurities arising for example from their production processes. It is preferable to use the purest possible components. It will further be appreciated that these impurities may also be present in the event of an closed-ended wording of the composition.

The compositions according to the invention exhibit no significant tracking current (>0.5 A over 2 s) when at least 50 drops of a 0.1% ammonium chloride solution are applied at 375 V, further preferably at 400 V, particularly preferably at 600 V, with the test preferably being carried out according to the rapid test method based on IEC 60112:2009 and described in the description part. Preferably, the compositions according to the invention have a flame retardancy V0 according to UL 94 V in thicknesses of the test specimens of 3 mm, further preferably at thicknesses of the test specimens of 2 mm, further preferably still also of at least V1 at 1.5 mm, in each case after conditioning the test specimens for 7 days at 50% relative humidity and 70° C. ambient temperature. In addition to the high CTI and good flame retardancy, the compositions preferably also have a good heat distortion resistance, which is manifested in a Vicat softening temperature, determined according to ISO 306:2014-3, VST Method B, of at least 110° C.

The invention accordingly also provides for the use of >2.0% by weight to 6.0% by weight, preferably to <5.0% by weight, of polyethylene, 2.5% to <8.0% by weight of phosphorus-containing flame retardant and 0.2% to 2.0% by weight of fluorine-containing anti-drip agent, wherein the % by weight figures are based on the resulting overall composition, for attaining a CTI of 600 V and a UL94 V0 classification at a test specimen thickness of 3 mm, preferably at a test specimen thickness of 2 mm, further preferably also of at least V1 at 1.5 mm, especially after conditioning the test specimens for 7 days at 50% relative humidity and 70° C. ambient temperature, in a thermoplastic composition containing at least 70% by weight of aromatic polycarbonate.

Of course, the features mentioned as preferred, particularly preferred, and so on, for the composition also apply with regard to the use according to the invention.

### DESCRIPTION

The individual constituents of the compositions according to the invention are more particularly elucidated hereinbelow:

### Component A

Component A of the compositions according to the invention are aromatic polycarbonates.

Aromatic polycarbonates in the context of the present invention include not only homopolycarbonates but also copolycarbonates and/or polyestercarbonates; the polycarbonates may be linear or branched in a known manner. Mixtures of polycarbonates may also be used according to the invention.

The thermoplastic polycarbonates, including the thermoplastic aromatic polyestercarbonates, preferably have weight-average molecular weights M_{w} of 15 000 g/mol to 40 000 g/mol, more preferably to 34 000 g/mol, particularly preferably of 17 000 g/mol to 33 000 g/mol, in particular of 19 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

The melt volume flow rate MVR of the aromatic polycarbonate used, determined in accordance with ISO 1133:2012-03, at a test temperature of 300° C. and 1.2 kg load, is preferably 5 to 35 cm³/(10 min), further preferably 6 cm³/(10 min) to 25 cm³/(10 min), further preferably still 6 to 21 cm³/(10 min).

A portion of up to 80 mol %, preferably of 20 mol % to 50 mol %, of the carbonate groups in the polycarbonates used according to the invention may be replaced by aromatic dicarboxylic ester groups.

Polycarbonates of this type that have not only acid moieties derived from carbonic acid but also acid moieties derived from aromatic dicarboxylic acids incorporated into the molecular chain are referred to as aromatic polyestercarbonates. For the purposes of the present invention, they are subsumed within the umbrella term “thermoplastic aromatic polycarbonates”.

Details of the preparation of polycarbonates have been set out in many patent specifications over the past 40 years or so. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to U. Grigo, K. Kirchner and P. R. Müller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

Aromatic polycarbonates are prepared, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is preparation via a melt polymerization method, by reacting dihydroxyaryl compounds with, for example, diphenyl carbonate.

For the preparation of the polyestercarbonates, a portion of the carbonic acid derivatives are replaced by aromatic dicarboxylic acids or derivatives of the dicarboxylic acids, and specifically by aromatic dicarboxylic ester structural units according to the carbonate structural units to be replaced in the aromatic polycarbonates.

Dihydroxyaryl compounds suitable for the preparation of polycarbonates are those of the formula (1)

HO—Z—OH (1),

in which
Z is an aromatic radical which has 6 to 30 carbon atoms, may contain one or more aromatic rings, may be substituted and may contain aliphatic or cycloaliphatic radicals or alkylaryls or heteroatoms as bridging elements.

It is preferable for Z in formula (1) to be a radical of formula (2)

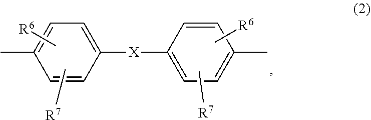

in which
R⁶ and R⁷ independently of one another are H, C₁- to C₁₈-alkyl, C₁- to C₁₈-alkoxy, halogen such as Cl or Br or in each case optionally substituted aryl or aralkyl, preferably H or C₁- to C₁₂-alkyl, particularly preferably H or C₁- to C₈-alkyl and very particularly preferably H or methyl, and
X is a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else C₆- to C₁₂-arylene which may optionally be fused to further aromatic rings containing heteroatoms.

X is preferably a single bond, C₁- to C₅-alkylene, C₂- to C₅-alkylidene, C₅- to C₆-cycloalkylidene, —O—, —SO—, —CO—, —S—, —SO₂—

or a radical of formula (3)

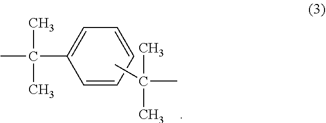

Examples of dihydroxyaryl compounds are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

Dihydroxyaryl compounds suitable for the preparation of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the dihydroxyaryl compounds (I) to (III)

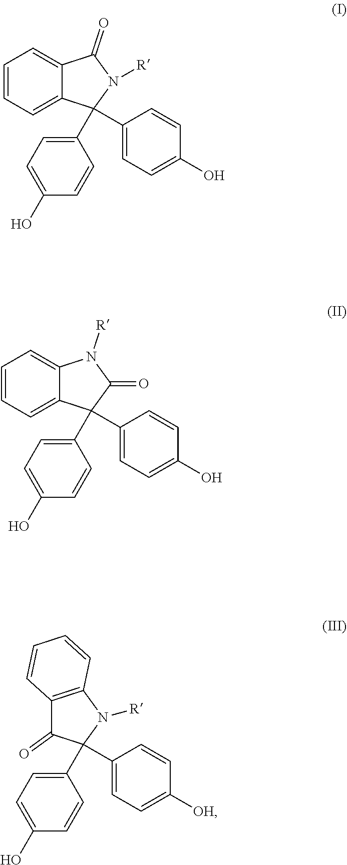

in which each R′ is a C₁- to C₄-alkyl radical, aralkyl radical or aryl radical, preferably a methyl radical or phenyl radical, very particularly preferably a methyl radical.

Particularly preferred dihydroxyaryl compounds are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,635 A, 2,999,835 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964” and also in JP 62039/1986 A, JP 62040/1986 A and JP 105550/1986 A.

In the case of the homopolycarbonates, only one dihydroxyaryl compound is used; in the case of the copolycarbonates, two or more dihydroxyaryl compounds are used.

Examples of suitable carbonic acid derivatives are phosgene or diphenyl carbonate.

Suitable chain terminators that may be used in the preparation of the polycarbonates are monophenols. Examples of suitable monophenols include phenol itself, alkylphenols such as cresols, p-tert-butylphenol, cumylphenol, and also mixtures thereof.

Preferred chain terminators are the phenols which have substitution by one or more linear or branched, preferably unsubstituted, C₁- to C₃₀-alkyl radicals, or by tert-butyl. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators can be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents are 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane, and 1,4-bis((4′,4″-dihydroxytriphenyl)methyl)benzene, and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane or the two monomers bisphenol A and 4,4′-dihydroxydiphenyl, and homo- or copolycarbonates derived from the dihydroxyaryl compounds of formulae (I), (II) and/or (III)

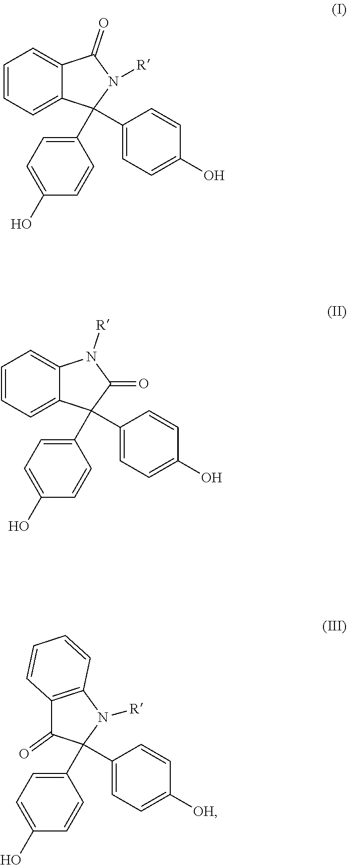

in which each R′ is C₁- to C₄-alkyl, aralkyl or aryl, preferably methyl or phenyl, very particularly preferably methyl,
   especially with bisphenol A. Very particularly preferably, the aromatic polycarbonate comprises a bisphenol A-based homopolycarbonate. Exceptionally preferably, the aromatic polycarbonate is bisphenol A-based homopolycarbonate.

The total proportion of the monomer units based on the formulae (I), (II), (III), 4,4′-dihydroxydiphenyl and/or bisphenol TMC in the copolycarbonate is preferably 0.1-88 mol %, particularly preferably 1-86 mol %, very particularly preferably 5-84 mol % and in particular 10-82 mol % (based on the sum total of the moles of dihydroxyaryl compounds used).

The relative solution viscosity of the copolycarbonates, determined in accordance with ISO 1628-4:1999, is preferably in the range of 1.15-1.35.

The dihydroxyaryl compounds used, similarly to all other chemicals and auxiliaries added to the synthesis, may be contaminated with the contaminants from their own synthesis, handling and storage. It is however desirable to work with the purest possible raw materials.

Also preferred are copolycarbonates prepared using diphenols of general formula (4a):

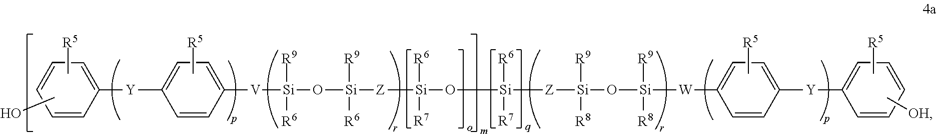

where
R⁵ is hydrogen or C₁- to C₄-alkyl, C₁- to C₃-alkoxy, preferably hydrogen, methoxy or methyl,
R⁶, R⁷, R⁸ and R⁹ each independently of one another are C₁- to C₄-alkyl or C₆- to C₁₂-aryl, preferably methyl or phenyl,
Y is a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or is a C₅- to C₆-cycloalkylidene radical which may be mono- or polysubstituted by C₁- to C₄-alkyl, preferably is a single bond, —O—, isopropylidene or a C₅- to C₆-cycloalkylidene radical which may be mono- or polysubstituted by C₁- to C₄-alkyl,
V is oxygen, C₂- to C₆-alkylene or C₃- to C₆-alkylidene, preferably oxygen or C₃-alkylene,
p, q and r are each independently 0 or 1,
when q=0, W is a single bond, when q=1 and r=0, W is oxygen, C₂- to C₆-alkylene or C₃- to C₆-alkylidene, preferably oxygen or C₃-alkylene,
when q=1 and r=1, W and V each independently are C₂- to C₆-alkylene or C₃- to C₆-alkylidene, preferably C₃-alkylene,
Z is a C₁- to C₆-alkylene, preferably C₂-alkylene,
is an average number of repeating units of from 10 to 500, preferably 10 to 100, and
m is an average number of repeating units of from 1 to 10, preferably 1 to 6, more preferably 1.5 to 5. It is likewise possible to use diphenols in which two or more siloxane blocks of general formula (4a) are joined to one another via terephthalic acid and/or isophthalic acid to form ester groups.

Especial preference is given to (poly)siloxanes of formulae (5) and (6)

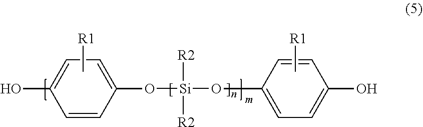

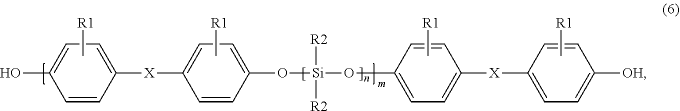

in which R1 is hydrogen, C₁- to C₄-alkyl, preferably hydrogen or methyl and especially preferably hydrogen,
each R2 independently is aryl or alkyl, preferably methyl,
X is a single bond, —SO₂—, —CO—, —O—, —S—, C₁- to C₆-alkylene, C₂- to C₅-alkylidene or C₆- to C₁₂-arylene which may optionally be fused to further aromatic rings containing heteroatoms,
X preferably is a single bond, C₁- to C₅-alkylene, C₂- to C₅-alkylidene, C₅- to C₁₂-cycloalkylidene, —O—, —SO— —CO—, —S—, —SO₂—, particularly preferably X is a single bond, isopropylidene, C₅- to C₁₂-cycloalkylidene or oxygen, and very particularly preferably is isopropylidene,
n is an average number of from 10 to 400, preferably 10 to 100, especially preferably 15 to 50 and
m is an average number of from 1 to 10, preferably from 1 to 6 and especially preferably from 1.5 to 5.

The siloxane block may likewise preferably be derived from the following structure

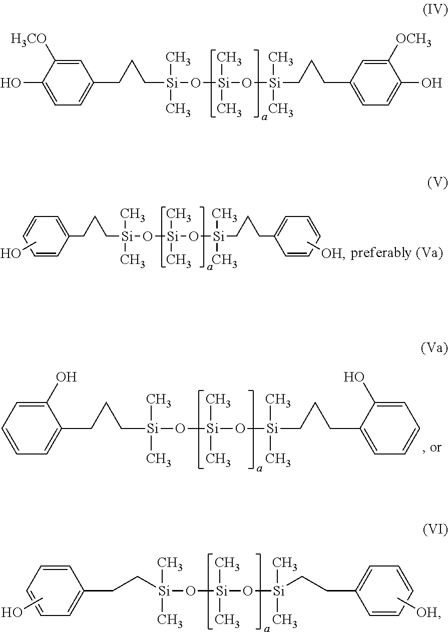

wherein a in formulae (IV), (V) and (VI) is an average number of from 10 to 400, preferably 10 to 100 and particularly preferably 15 to 50.

It is likewise preferable when at least two identical or different siloxane blocks of general formulae (IV), (V) or (VI) are joined to one another via terephthalic acid and/or isophthalic acid to form ester groups.

It is likewise preferable when in formula (4a) p=0, V is C₃-alkylene, r=1, Z is C₂-alkylene, R⁸ and R⁹ are methyl, q=1, W is C₃-alkylene, m=1, R⁵ is hydrogen or C₁- to C₄-alkyl, preferably hydrogen or methyl, R⁶ and R⁷ each independently of one another are C₁- to C₄-alkyl, preferably methyl, and o is 10 to 500.

Copolycarbonates having monomer units of formula (4a) and in particular also the preparation thereof are described in WO 2015/052106 A2.

Copolycarbonates having monomer units of formula (IV) and in particular also the preparation thereof are described in WO 2015/052106 A2.

Examples of aromatic dicarboxylic acids that are suitable for the preparation of the polyestercarbonates include orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenylsulfonedicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of dicarboxylic acids are dicarbonyl dihalides and dialkyl dicarboxylates, especially dicarbonyl dichlorides and dimethyl dicarboxylates.

Replacement of the carbonate groups by the aromatic dicarboxylic ester groups is substantially stoichiometric, and also quantitative, and the molar ratio of the reactants is therefore also maintained in the final polyestercarbonate. The aromatic dicarboxylic ester groups may be incorporated either randomly or in blocks.

The compositions according to the invention contain at least 70% by weight, preferably at least 75% by weight, more preferably at least 78% by weight, more preferably still >79.0% by weight, particularly preferably at least 83% by weight, very particularly preferably 85% by weight to <95.3% by weight, especially up to 93.8% by weight, of aromatic polycarbonate, and are thus based on aromatic polycarbonate.

### Component B

Component B is a polyethylene. Component B is preferably an HDPE (high density polyethylene), HMWPE (high molecular weight polyethylene), UHMWPE (ultra high molecular weight PE) or a combination thereof.

HDPE is typically weakly branched and has a density of 0.94-0.97 g/cm³ determined according to ASTM D1505-18. The weight-average molecular weight is preferably >200 000 g/mol, determined by high-temperature GPC in 1,2,4-trichlorobenzene.

HMWPE typically has a molecular weight M_{w} of 500 000-1 000 000 g/mol determined by high-temperature GPC in 1,2,4-trichlorobenzene.

UHMWPE typically has a molecular weight M_{w} of >1 000 000 up to 6 000 000 g/mol, preferably from 4 000 000 to 6 000 000, determined by high-temperature GPC in 1,2,4-trichlorobenzene, and the density is 0.93-0.94 g/cm³, determined according to ASTM D1505-18.

The proportion of component B in the compositions according to the invention is >2.0% by weight to 6.0% by weight, preferably up to <5.0% by weight, more preferably 3% by weight to 4% by weight, particularly preferably 3.0% to 4.0% by weight, based on the overall composition.

### Component C

Component C of the compositions according to the invention is phosphorus-containing flame retardants. It may be a single phosphorus-containing flame retardant, but it may also be a mixture of various phosphorus-containing flame retardants.

Preferred phosphorus-containing flame retardants are cyclic phosphazenes, phosphorus compounds of formula (10), and mixtures thereof:

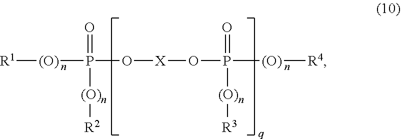

in which
R¹, R², R³ and R⁴ independently of one another are a C₁- to C₈-alkyl radical, in each case optionally halogenated and in each case branched or unbranched, and/or C₅- to C₆-cycloalkyl radical, C₆- to C₂O-aryl radical or C₇- to C₁₂-aralkyl radical, in each case optionally substituted by branched or unbranched alkyl, and/or halogen, preferably chlorine and/or bromine,
n is independently 0 or 1,
q is a value from 0 to 30 and
X is a mono- or polycyclic aromatic radical having 6 to 30 carbon atoms or a linear or branched aliphatic radical having 2 to 30 carbon atoms, each of which may be substituted or unsubstituted, and bridged or unbridged.

Preferably, R¹, R², R³ and R⁴ independently of one another are branched or unbranched C₁- to C₄-alkyl, phenyl, naphthyl or C₁- to C₄-alkyl-substituted phenyl. In the case of aromatic R¹, R², R³ and/or R⁴ groups, these may in turn be substituted by halogen and/or alkyl groups, preferably chlorine, bromine and/or C₁- to C₄-alkyl, branched or unbranched. Particularly preferred aryl radicals are cresyl, phenyl, xylenyl, propylphenyl or butylphenyl, and also the corresponding brominated and chlorinated derivatives thereof.

X in formula (10) is preferably derived from dihydroxyaryl compounds.

X in formula (10) is particularly preferably

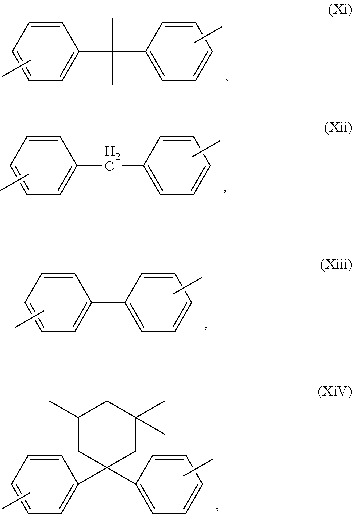

or the chlorinated and/or brominated derivatives thereof. X (together with the adjoining oxygen atoms) is preferably derived from hydroquinone, bisphenol A or diphenylphenol. It is likewise preferable for X to be derived from resorcinol. Particularly preferably, X is derived from bisphenol A. n in formula (10) is preferably equal to 1. q is preferably 0 to 20, particularly preferably 0 to 10, and in the case of mixtures is average values of 0.8 to 5.0, preferably 1.0 to 3.0, more preferably 1.05 to 2.00 and particularly preferably 1.08 to 1.60.

The phosphorus compound of general formula (10) is preferably a compound of formula (11):

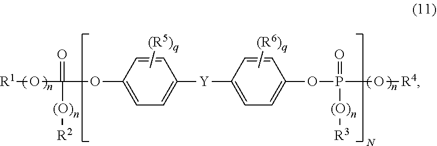

in which
R¹, R², R³ and R⁴ are each independently a linear or branched C₁- to C₈-alkyl radical and/or optionally linear- or branched-alkyl-substituted C₅- to C₆-cycloalkyl radical, C₆- to C₁₀-aryl radical or C₇- to C₁₂-aralkyl radical,
n is independently 0 or 1,
q is independently 0, 1, 2, 3 or 4,
N is a number between 1 and 30,
R₅ and R₆ independently of one another are linear or branched C₁- to C₄-alkyl radical, preferably methyl radical, and
Y is linear or branched C₁- to C₇-alkylidene, a linear or branched C₁- to C₇-alkylene radical, C₅- to C₁₂-cycloalkylene radical, C₅- to C₁₂-cycloalkylidene radical, —O—, —S—, —SO—, SO₂ or —CO—.

Phosphorus compounds of the formula (10) are especially tributyl phosphate, triphenyl phosphate, tricresyl phosphate, diphenyl cresyl phosphate, diphenyl octyl phosphate, diphenyl 2-ethylcresyl phosphate, tri(isopropylphenyl) phosphate, resorcinol-bridged oligophosphate and bisphenol A-bridged oligophosphate. The use of oligomeric phosphoric esters of formula (10) which are derived from bisphenol A is especially preferred.

Further preference is given to using mixtures of identical structure and different chain length, with the stated q value being the average q value. The average q value is determined by determining the composition of the phosphorus compound mixture (molecular weight distribution) by means of high pressure liquid chromatography (HPLC) at 40° C. in a mixture of acetonitrile and water (50:50) and using this to calculate the average values of q.

Particularly preferably, bisphenol A-based oligophosphate (bisphenol A bis(diphenyl phosphate)) according to formula (12) with q=1 to 20, in particular with q=1.0 to 1.2, is present in the compositions according to the invention.

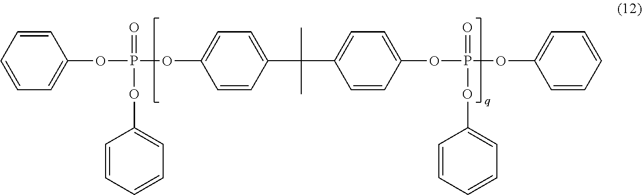

Phosphorus compounds of this kind are known (cf., for example, EP 0 363 608 A1, EP 0 640 655 A2) or can be prepared in an analogous manner by known methods (e.g. Ullmanns Enzyklopädie der technischen Chemie [Ullmann's Encyclopedia of Industrial Chemistry], vol. 18, p. 301 ff. 1979; Houben-Weyl, Methoden der organischen Chemie [Methods of Organic Chemistry], vol. 12/1, p. 43; Beilstein vol. 6, p. 177).

Just as preferably as the phosphorus compounds according to formula (10), it is possible to use cyclic phosphazenes according to formula (13) as component C:

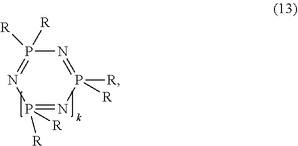

where
R in each case is identical or different and is
   an amine radical,
   an in each case optionally halogenated, preferably fluorine-halogenated, more preferably monohalogenated, C₁- to C₈-alkyl radical, preferably methyl radical, ethyl radical, propyl radical or butyl radical,
   a C₁- to C₈-alkoxy radical, preferably a methoxy radical, ethoxy radical, propoxy radical or butoxy radical,
   an in each case optionally alkyl-substituted, preferably C₁- to C₄-alkyl-substituted, and/or halogen-substituted, preferably chlorine- and/or bromine-substituted, C₅- to C₆-cycloalkyl radical,
   an in each case optionally alkyl-substituted, preferably C₁- to C₄-alkyl-substituted, and/or halogen-substituted, preferably chlorine-, bromine-, and/or hydroxy-substituted, C₆- to C₂O-aryloxy radical, preferably phenoxy radical, naphthyloxy radical,
   an in each case optionally alkyl-substituted, preferably C₁- to C₄-alkyl-substituted, and/or halogen-substituted, preferably chlorine- and/or bromine-substituted, C₇- to C₁₂-aralkyl radical, preferably phenyl-C₁- to C₄-alkyl radical, or
   a halogen radical, preferably chlorine or fluorine, or
   an OH radical,
k is a whole number from 1 to 10, preferably a number from 1 to 8, particularly preferably 1 to 5, very particularly preferably is 1.

Particularly preferably used according to the invention are commercially available phosphazenes. These are typically mixtures of rings of different ring sizes.

Further preference is given, either individually or in a mixture, to: propoxyphosphazene, phenoxyphosphazene, methylphenoxyphosphazene, aminophosphazene, fluoroalkylphosphazenes, and also phosphazenes having the following structures:

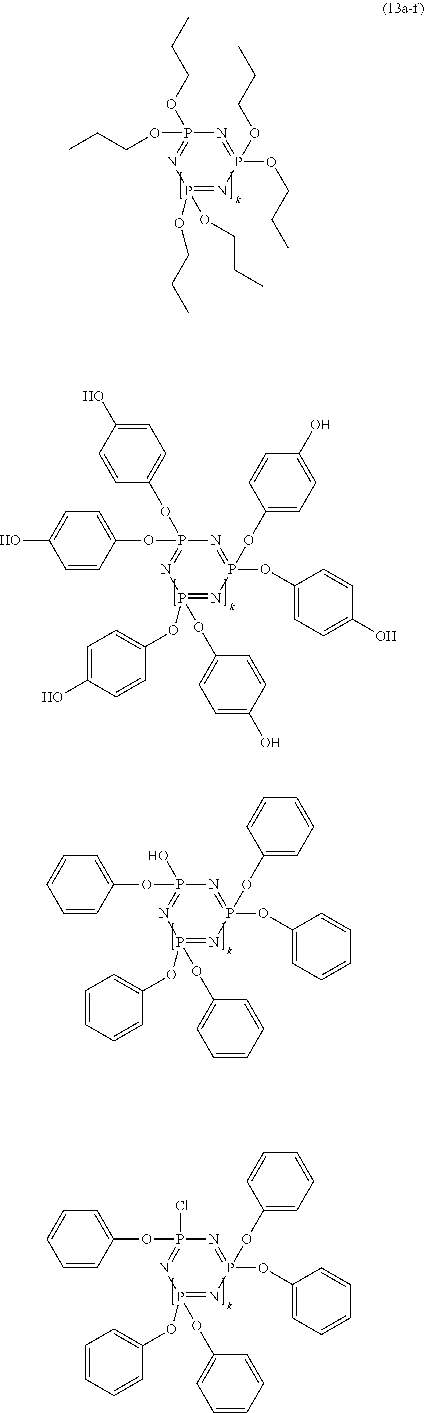

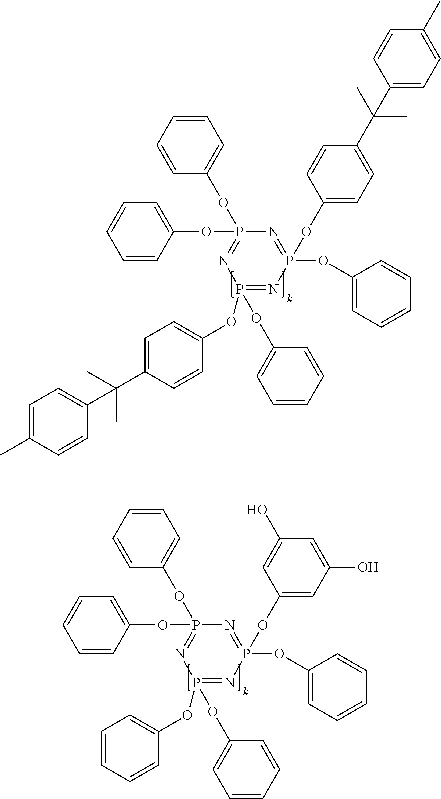

In the compounds 13a-f shown above, k=1, 2 or 3.

Preferably, the proportion of phosphazenes that are halogen-substituted on the phosphorus, for example composed of incompletely reacted starting material, is less than 1000 ppm, more preferably less than 500 ppm.

The phosphazenes can be used alone or in a mixture. The radical R may always be the same or two or more radicals in the formulae may be different. The radicals R of a phosphazene are preferably identical.

In one embodiment, solely phosphazenes having the same R are used.

Preferably, the proportion of tetramers (k=2) is from 2 to 50 mol %, based on component C, more preferably from 5 to 40 mol %, more preferably still from 10 to 30 mol %, particularly preferably from 10 to 22 mol %.

Preferably, the proportion of the higher oligomeric phosphazenes (k=3, 4, 5, 6 and 7) is from 0 to 30 mol %, based on component C, more preferably from 2.5 to 25 mol %, more preferably still from 5 to 20 mol %, and particularly preferably from 6-15 mol %.

Preferably, the proportion of oligomers with k≥8 is from 0 to 2.0 mol %, based on component C, and preferably from 0.10 to 1.00 mol %.

More preferably, the phosphazenes of component C satisfy all three above-mentioned conditions with respect to the proportions of oligomers.

Particularly preferably present as component C is phenoxyphosphazene (all R=phenoxy, formula 13g), alone or with further phosphazenes according to formula (13) as component C, with a proportion of oligomers with k=1 (hexaphenoxyphosphazene) of 50 to 98 mol %, particularly preferably 60 to 72% by weight, based on the amount of phenoxyphosphazene. If phenoxyphosphazene is used, the proportion of oligomers with k=2 is very particularly preferably: 15% to 22% by weight and with k ≥3: 10% to 13% by weight.

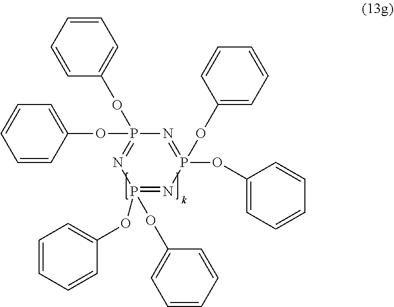

Alternatively, component C very particularly preferably comprises, and very particularly preferably is, a phenoxyphosphazene having a trimer content (k=1) of 70 to 85 mol %, a tetramer content (k=2) of 10 to 20 mol %, a proportion of higher oligomeric phosphazenes (k=3, 4, 5, 6 and 7) of 3 to 8 mol % and phosphazene oligomers with k ≥8 of 0.1 to 1 mol %, based on component C.

In an alternative preferred embodiment, n, defined as the arithmetic mean of k, is in the range from 1.10 to 1.75, preferably from 1.15 to 1.50, more preferably from 1.20 to 1.45, and particularly preferably from 1.20 to 1.40 (range boundaries included).

$$n = \frac{{\sum }_{i = 1}^{max} {k}_{i} \cdot {x}_{i}}{{\sum }_{i = 1}^{max} {x}_{i}} \qquad ( 14 )$$

Phosphazenes and the preparation thereof are described, for example, in EP 728 811 A2, DE 1961668 A and WO 97/40092 A1.

The oligomer compositions in the respective blend samples can be detected and quantified after compounding by means of ³¹P NMR (chemical shift; δ trimer: 6.5 to 10.0 ppm; δ tetramer: −10 to −13.5 ppm; δ higher oligomers: −16.5 to −25.0 ppm).

Very particularly preferably, component C comprises bisphenol A-based oligophosphate according to formula (12) and/or cyclic phosphazene according to formula (13), most preferably component C is bisphenol A-based oligophosphate according to formula (12) and/or cyclic phosphazene according to formula (13).

The proportion of phosphorus-containing flame retardant in the compositions according to the invention is 2.5% by weight to <8.0% by weight, preferably 3% by weight to 6% by weight, particularly preferably 4% to 6% by weight, very particularly preferably 4.0% to 6.0% by weight, based on the overall composition.

### Component D

The compositions according to the invention contain as component D a fluorine-containing anti-drip agent, which may be a mixture of two or more anti-drip agents. The total amount of anti-drip agent (anti-dripping agent) is 0.2% by weight to 2.0% by weight, preferably 0.21% by weight to 1.6% by weight, particularly preferably 0.25% by weight to 1.0% by weight of at least one anti-drip agent.

As the anti-drip agent, a fluorinated polymer, in particular polyolefin, is preferably used.

The fluorinated polyolefins used with preference as anti-drip agents have high molecular weight and have glass transition temperatures of above −30° C., generally of above 100° C., and fluorine contents preferably of from 65% by weight to 76% by weight, in particular from 70% to 76% by weight. Preferred fluorinated polyolefins are polytetrafluoroethylene, polyvinylidene fluoride, tetrafluoroethylene/hexafluoropropylene copolymers and ethylene/tetrafluoroethylene copolymers. Fluorinated polyolefins are known (cf. “Vinyl and Related Polymers” by Schildknecht, John Wiley & Sons, Inc., New York, 1962, pages 484-494; “Fluoropolymers” by Wall, Wiley-Interscience, John Wiley & Sons, Inc., New York, volume 13, 1970, pages 623-654; “Modern Plastics Encyclopedia”, 1970-1971, volume 47, No. 10 A, October 1970, McGraw-Hill, Inc., New York, pages 134 and 774; “Modern Plastics Encyclopedia”, 1975-1976, October 1975, volume 52, No. 10 A, McGraw-Hill, Inc., New York, pages 27, 28 and 472 and U.S. Pat. No. 3,671,487 A, 3 723 373 A and 3 838 092 A). They can be prepared by known methods, for example by polymerizing tetrafluoroethylene in aqueous medium with a free-radical-forming catalyst, for example sodium, potassium or ammonium peroxydisulfate, at pressures of from 7 to 71 kg/cm² and at temperatures of from 0 to 200° C., preferably at temperatures of from 20 to 100° C. More details are given, for example, in U.S. Pat. No. 2,393,967 A.

Depending on the use form, the density of the fluorinated polyolefins can lie between 1.2 and 2.3 g/cm³, preferably 2.0 g/cm³ to 2.3 g/cm³, determined in accordance with ISO 1183-1 (2019-09), and the median particle size between 0.05 and 1000 μm, determined by light microscopy or white light interferometry.

Suitable tetrafluoroethylene polymer powders are commercial products and are available by way of example from DuPont under the trade name Teflon®.

Particular preference is given to using polytetrafluoroethylene (PTFE), as such, but also in the form of a PTFE-containing composition, as a fluorine-containing anti-drip agent. If a PTFE-containing composition is used, the minimum use amount thereof is enough for at least 0.2% by weight, preferably at least 0.21% by weight, particularly preferably at least 0.25% by weight, of PTFE to be present in the overall composition. The PTFE-containing compositions include Hostaflon® TF2021 or PTFE blends such as Blendex® B449 (about 50% by weight of PTFE and about 50% by weight of SAN [from 80% by weight of styrene and 20% by weight of acrylonitrile]) from Chemtura. Very particular preference is given to using PTFE or a PTFE/SAN blend as fluorine-containing anti-drip agent.

### Component E

The polycarbonate compositions according to the invention may contain one or more further additives different from components B, C and D, which are subsumed in the present case under “component E”.

Optionally (0% by weight), preferably up to 20% by weight, more preferably up to 10% by weight, more preferably still 0.1% by weight to 5% by weight, particularly preferably 0.1% by weight to 3% by weight, very particularly preferably 0.2% by weight to 1.0% by weight, of other customary additives (“further additives”) are present, these percentages by weight being based on the total weight of the composition. The group of further additives does not include any phosphorus-containing flame retardant according to component C. The group of further additives in particular also does not include any fluorine-containing anti-drip agent, as this is already described as component D.

Such further additives, as are typically added to polycarbonates, are in particular heat stabilizers, antioxidants, mold-release agents, UV absorbers, IR absorbers, impact modifiers, antistats, flame retardants different from component C, optical brighteners, fillers, light-scattering agents, hydrolysis stabilizers, transesterification stabilizers, (organic) dyes, (organic/inorganic) pigments, compatibilizers, flow improvers and/or additives for laser marking, in particular in the amounts typical for polycarbonate-based compositions. Such additives are described, for example, in EP 0 839 623 A1, WO 96/15102 A1, EP 0 500 496 A1 or in “Plastics Additives Handbook”, Hans Zweifel, 5th Edition 2000, Hanser Verlag, Munich. These additives may be added individually or else in a mixture and are additives that are preferred according to the invention.

More preferably present as further additives, where further additives are present at all, are one or more further additives selected from the group consisting of heat stabilizers, antioxidants, mold-release agents, organic dyes, organic pigments, inorganic pigments. In particular, the proportion of further additives is preferably 0% to 3% by weight.

The further additive present is very particularly preferably at least one heat stabilizer, an antioxidant and/or a mold-release agent.

It will be appreciated that only such additives may be added, and only in such amounts, where they do not significantly negatively impact the effect of the invention of high CTI and good flame retardancy and preferably also do not lower the Vicat temperature, determined according to ISO 306:2014-3, VST Method B, below 110° C. Therefore, in addition to the phosphorus-containing flame retardants according to component C, it is extremely preferable for no more than 0.05% by weight of further flame retardants to be present.

The compositions according to the invention may contain, in addition to component C, further flame retardants, but are free of those selected from the group of alkali metal, alkaline earth metal or ammonium salts of aliphatic or aromatic sulfonic acid, sulfonamide or sulfonimide derivatives, and combinations thereof, with “derivatives” being understood to mean those compounds having a molecular structure that in place of a hydrogen atom or a functional group possesses a different atom or a different atom group or in which one or more atoms/atom groups has/have been removed. The parent compound is thus still recognizable.

Such flame retardants that are not present in compositions according to the invention are in particular one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, or mixtures thereof, among these particularly preferably sodium or potassium perfluorobutanesulfate, sodium or potassium perfluorooctanesulfate, sodium or potassium diphenylsulfone sulfonate, or mixtures thereof, especially potassium perfluoro-1-butanesulfonate, which is commercially available, inter alia, as Bayowet® C4 from Lanxess, Leverkusen, Germany.

Additives particularly preferably present are mold-release agents, more preferably based on a fatty acid ester, more preferably still based on a stearic ester, especially preferably based on pentaerythritol. Particular preference is given to using pentaerythritol tetrastearate (PETS) and/or glycerol monostearate (GMS). If one or more mold-release agents are used, the amount is preferably up to 1.0% by weight (inclusive), more preferably 0.01% to 0.7% by weight, particularly preferably 0.02% to 0.60% by weight, based in each case on the overall composition. In addition, the amount of fluorine-containing anti-drip agent, where a mold-release agent is present, is at least 0.5% by weight, particularly preferably at least 0.5% by weight of PTFE.

Additives present with particular preference are also heat stabilizers. The amount of heat stabilizer is preferably up to 0.20% by weight, more preferably 0.01% to 0.10% by weight, more preferably still 0.01% to 0.05% by weight, particularly preferably 0.015% to 0.040% by weight, based on the overall composition.

Suitable heat stabilizers are in particular phosphorus-based stabilizers selected from the group of the phosphates, phosphites, phosphonites, phosphines and mixtures thereof. Examples include triphenyl phosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl) phosphite (Irgafos® 168), diisodecyl pentaerythritol diphosphite, bis(2,4-di-tert-butylphenyl) pentaerythritol diphosphite, bis(2,4-dicumylphenyl) pentaerythritol diphosphite (Doverphos® S-9228), bis(2,6-di-tert-butyl-4-methylphenyl) pentaerythritol diphosphite, diisodecyloxy pentaerythritol diphosphite, bis(2,4-di-tert-butyl-6-methylphenyl) pentaerythritol diphosphite, bis(2,4,6-tris(tert-butylphenyl) pentaerythritol diphosphite, tristearyl sorbitol triphosphite, tetrakis(2,4-di-tert-butylphenyl)-4,4′-biphenylenediphosphonite, 6-isooctyloxy-2,4,8,10-tetra-tert-butyl-12H-dibenzo[d,g]-1,3,2-dioxaphosphocine, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyldibenzo[d,g]-1,3,2-dioxaphosphocine, 2,2′,2″-nitrilo[triethyltris(3,3′,5,5′-tetra-tert-butyl-1,1′-biphenyl-2,2′-diyl) phosphite], 2-ethylhexyl(3,3′,5,5′-tetra-tert-butyl-1,1′-biphenyl-2,2′-diyl) phosphite, 5-butyl-5-ethyl-2-(2,4,6-tri-tert-butylphenoxy)-1,3,2-dioxaphosphirane, bis(2,6-di-tert-butyl-4-methylphenyl)pentaerythritol diphosphite, triphenylphosphine (TPP), trialkylphenylphosphine, bisdiphenylphosphinoethane or a trinaphthylphosphine. They are used alone or in a mixture, for example Irganox® B900 (mixture of Irgafos® 168 and Irganox® 1076 in a 4:1 ratio) or Doverphos® S-9228 with Irganox® B900/Irganox® 1076. Especially preferably, triphenylphosphine (TPP), Irgafos® 168 or tris(nonylphenyl) phosphite, or mixtures thereof, are used.

It is also possible to use phenolic antioxidants such as alkylated monophenols, alkylated thioalkylphenols, hydroquinones and alkylated hydroquinones. Particular preference is given to using Irganox® 1010 (pentaerythritol 3-(4-hydroxy-3,5-di-tert-butylphenyl)propionate; CAS: 6683-19-8) and Irganox 1076® (octadecyl 3-(3,5-di-tert-butyl-4-hydroxyphenyl)propionate), preferably in amounts of 0.05%-0.5% by weight.

It is also possible to add sulfonic esters or alkyl phosphates, for example mono-, di- and/or trihexyl phosphate, triisooctyl phosphate and/or trinonyl phosphate, as transesterification inhibitors. The alkyl phosphate used is preferably triisooctyl phosphate (tris-2-ethylhexyl phosphate). It is also possible to use mixtures of various mono-, di- and trialkyl phosphates. Triisooctyl phosphate is preferably used in amounts of from 0.003% by weight to 0.05% by weight, more preferably 0.005% by weight to 0.04% by weight and particularly preferably from 0.01% by weight to 0.03% by weight, based on the overall composition.

Examples of impact modifiers are: core-shell polymers such as ABS or MBS; olefin-acrylate copolymers such as for example the Elvaloy® types from DuPont or Paraloid® types from Dow; silicone acrylate rubbers such as for example the Metablen® types from Mitsubishi Rayon Co., Ltd. The compositions according to the invention already have an exceptional profile of properties without additional impact modifiers. Compositions according to the invention are therefore preferably free of impact modifiers.

Particularly preferably, no fillers are present in the compositions according to the invention.

Compositions particularly preferred according to the invention consist of
A) >79.0% by weight of aromatic polycarbonate,
B) >2.0% by weight to 6.0% by weight, in particular <5.0% by weight, of polyethylene,
C) 2.5% by weight to <8.0% by weight of phosphorus-containing flame retardant,
D) 0.2% by weight to 2.0% by weight of fluorine-containing anti-drip agent, wherein, if the composition contains >4.0% by weight of polyethylene, at least 0.5% by weight of fluorine-containing anti-drip agent is present,
E) 0% to 5% by weight of one or more further additive(s), selected from the group consisting of heat stabilizers, antioxidants, mold-release agents, UV absorbers, IR absorbers, antistats, flame retardants different from component C, excluding alkali metal, alkaline earth metal or ammonium salts of aliphatic or aromatic sulfonic acid, sulfonamide or sulfonimide derivatives, optical brighteners, light-scattering agents, hydrolysis stabilizers, transesterification stabilizers, organic dyes, organic pigments, inorganic pigments, compatibilizers, flow improvers, additives for laser marking, and mixtures thereof.

Compositions very particularly preferred according to the invention consist of
A) 83% by weight to 93.8% by weight of aromatic polycarbonate,
B) 3% by weight to 4% by weight of polyethylene,
C) 3% by weight to 6% by weight of phosphorus-containing flame retardant,
D) 0.2% by weight to 2.0% by weight of fluorine-containing anti-drip agent, wherein, if the composition contains >4.0% by weight of polyethylene, at least 0.5% by weight of fluorine-containing anti-drip agent is present,
E) 0% to 5% by weight of one or more further additive(s), selected from the group consisting of heat stabilizers, antioxidants, mold-release agents, UV absorbers, IR absorbers, antistats, flame retardants different from component C, excluding alkali metal, alkaline earth metal or ammonium salts of aliphatic or aromatic sulfonic acid, sulfonamide or sulfonimide derivatives, optical brighteners, light-scattering agents, hydrolysis stabilizers, transesterification stabilizers, organic dyes, organic pigments, inorganic pigments, compatibilizers, flow improvers, additives for laser marking, and mixtures thereof.

The phosphorus-containing flame retardant present in this case is preferably either an organophosphate, in particular one of formula (12),

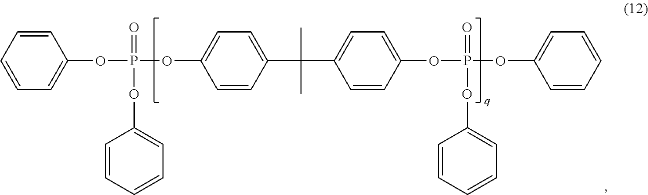

where q=1 to 20, in particular 1.0 to 1.2,
or a
phosphazene of formula (13g)

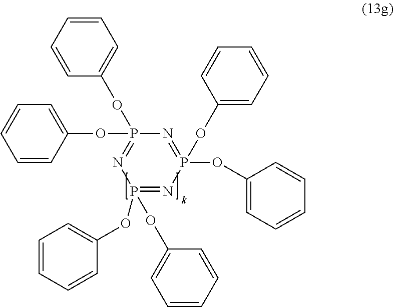

where k=1, 2 or 3, including mixtures thereof. It will be appreciated that this is preferably a mixture of various oligomers of this formula, since mixtures are commercially typically available. Very particular preference is given to the phosphorus-containing flame retardant of one of formulae (12) or (13g), as defined above.

In the compositions described as preferred, more preferred, particularly preferred etc., the molecular weight of the polyethylene used is preferably at least 200 000 g/mol, determined by high-temperature GPC in 1,2,4-trichlorobenzene.

The polymer compositions according to the invention, containing the mixed components A, B, C, D and optionally E and also optionally further constituents, may be prepared using powder premixes. It is also possible to use premixes of pellet materials or pellet materials and powders with the additions according to the invention. It is also possible to use premixes produced from solutions of the mixture components in suitable solvents, wherein homogenization is optionally effected in solution and the solvent is then removed. More particularly, the additives referred to as component E and also further constituents of the compositions according to the invention can be introduced by known methods or in the form of a masterbatch. The use of masterbatches is preferred in particular for the introduction of additives and further constituents, with masterbatches based on the respective polymer matrix being used in particular.

The compositions according to the invention may be extruded for example. After extrusion, the extrudate may be cooled and comminuted. The combining and mixing of a premix in the melt may also be effected in the plasticizing unit of an injection molding machine. In this case, the melt is directly converted into a molded article in the subsequent step.

Compositions according to the invention are preferably used for the production of moldings for components from the EE sector, in particular for high-voltage switches, inverters, relays, electronic connectors, electrical connectors, circuit breakers, components for photovoltaic applications, electric motors, heat sinks, chargers or charging plugs for electric vehicles, electrical junction boxes, smart meter housings, miniature circuit breakers, busbars.

The invention thus provides moldings consisting of, or comprising regions made from, compositions according to the invention, and also corresponding components or parts of components comprising elements, i.e. moldings, which consist of compositions according to the invention or comprise regions consisting of compositions according to the invention.

The component is preferably designed for an operating voltage of at least 400 V. However, it can also be designed for a typical household operating voltage of 230 V±23 V in Europe. However, lower distances between the electrical conductors can now be achieved.

The high comparative tracking index of the polycarbonate compositions according to the invention makes it possible, using the polycarbonate material, to achieve smaller distances between two electrical conductors of a component than was previously possible with the use of polycarbonate.

The invention therefore also provides an EE component, comprising a first electrical conductor and a second electrical conductor at a first distance d1 and a second distance d2 with respect to one another,
which are connected via an element made from a thermoplastic composition according to the invention, the latter being in direct contact with the first electrical conductor and the second electrical conductor,
wherein the distance d1 is the shortest distance between the first electrical conductor and the second electrical conductor along the surface of the element made from the thermoplastic composition and
wherein the distance d2 is the shortest distance between the first electrical conductor and the second electrical conductor through the air,
wherein d2 is selected in such a way that at the respective operating voltage a sparkover through the air is prevented and
wherein d1, at the operating voltage U listed below, is:
d1i(0 V≤U≤250 V): 1.8 mm to <2.5 mm
d1ii(250 V<U≤500 V)=3.6 mm to <5.0 mm
d1iii(500 V<U≤1000 V)=7.1 mm to <10.0 mm.

Such small distances can only be achieved with a material that at least has a CTI of 400 V.

“Element made from a thermoplastic composition according to the invention” here means that an element is present which consists of a thermoplastic composition according to the invention, i.e. the composition has not been mixed with additional components.

If the material has a CTI of 600 V, yet smaller distances are achievable, such that dl, at the operating voltage listed, is then preferably:
d1i(0 V≤U≤250 V): 1.3 mm to <2.5 mm,
d1ii(250 V<U≤500 V)=2.5 mm to <5.0 mm,
d1iii(500 V<U≤1000 V)=5.0 mm to <10.0 mm.

When using a material with a CTI of 600 V, d1 at the operating voltage listed is particularly preferably:
d1i(0 V≤U≤250 V): 1.3 mm to <1.8 mm,
d1ii(250 V<U≤500 V)=2.5 mm to <3.6 mm,
d1iii(500 V<U≤1000 V)=5.0 mm to <7.1 mm, distances that are not possible even with a material with a CTI of 400 or 450 V, but require a CTI of 600 V.

It is well known that the degree of soiling affects the electrical conductivity. The distances d1 and d2 mentioned are usable in practice in components in which, for example due to structural shielding, an IP6K9K degree of protection according to ISO 20653:2013-02 can be adhered to.

Thermoplastic compositions that are preferred according to the invention belong to insulating material group II (400 V≤CTI<600 V), very particularly preferred compositions belong to insulating material group I (600 V≤CTI), classified according to DIN EN 60664-1.

### Examples

### 1. Description of Raw Materials and Test Methods

### a) Raw Materials

Component A-1: Linear polycarbonate based on bisphenol A having a melt volume flow rate of 12 cm³/(10 min) (according to ISO 1133:2012-03, at a test temperature of 300° C. and with 1.2 kg load) containing as component E-3 250 ppm (=0.025% by weight, based on the total weight of component A) of triphenylphosphine heat stabilizer.

Component A-2: Linear polycarbonate based on bisphenol A having a melt volume flow rate of 6 cm³/(10 min) (according to ISO 1133:2012-03, at a test temperature of 300° C. and with 1.2 kg load).

Component B-1: UMFI 30X ultra-high molecular weight polyethylene (UHMWPE) from Shamrock Technologies having a median particle diameter (D₅₀) of 30 m, determined by laser diffraction according to ISO 13320:2009.

Component B-2: Formolene LH5320 high-density polyethylene from Formosa Plastics having a density of 0.953 g/cm³ determined according to ASTM D1505-18 and a melt volume flow rate of 20 g/10 min measured according to ASTM D1238-20.

Component C-1: Organophosphate of formula (12) with q=1.0-1.2. Bisphenol A bis(diphenyl phosphate) from Adeka.

Component C-2: Rabitle FP110 phenoxycyclophosphazene from Fushimi Pharmaceutical, Japan, formula (13g), with a trimer content (k=1) of approximately 68 mol %.

Component Cx: Potassium perfluoro-1-butanesulfonate, commercially available as Bayowet® C4 from Lanxess AG, Leverkusen, Germany, CAS no. 29420-49-3.

Component D-1: ADS5000 SAN-encapsulated polytetrafluoroethylene (approx. 50% by weight PTFE (fluorine-containing anti-drip agent) and approx. 50% by weight SAN) from Chemical Innovation Co., Ltd. Thailand.

Component D-2: Fluorine-containing anti-drip agent. Teflon CFP6000X polytetrafluoroethylene from Chemours Netherlands B.V.

Component E-1: Mold-release agent. Pentaerythritol tetrastearate, commercially available as Loxiol VPG 861 from Emery Oleochemicals Group.

Component E-2: Antioxidant. Irganox® B900 from BASF (mixture of Irgafos® 168 (tris(2,4-di-tert-butylphenyl) phosphite) and Irganox® 1076 (octadecyl 3-(3,5-di-tert-butyl-4-hydroxyphenyl)propionate) in a 4:1 ratio by weight).

### b) Test Methods

### Comparative Tracking Index (CTI):

In order to determine the comparative tracking index, the compositions described here were tested according to the rapid test method based on IEC 60112:2009. To this end, a 0.1% ammonium chloride test solution (395 ohm*cm resistance) was applied dropwise, between two neighboring electrodes spaced apart by 4 mm, to the surface of test specimens of dimensions 60 mm×40 mm×4 mm at a time interval of 30 s. A test voltage was applied between the electrodes and was varied over the course of the test. The first test specimen was tested at a starting voltage of 300 V or 350 V. A maximum of 50 drops (one drop every 30 s) in total were applied per voltage as long as no tracking current >0.5 A over 2 s occurred or the sample burned. After 50 drops, the voltage was increased by 50 V and a new test specimen was tested at this higher voltage, according to the procedure described above. This process was continued until either 600 V was reached or a tracking current or burning occurred. If one of the above-mentioned effects already occurred with fewer than 50 drops, the voltage was reduced by 25 V and a new test specimen was tested at this lower voltage. The voltage was reduced until the test was passed with 50 drops without tracking current or burning. This procedure was therefore used to determine the maximum possible voltage at which a composition could withstand 50 drops of the test solution without the occurrence of a tracking current. Lastly, four further test specimens were tested at the determined maximum voltage with 50 drops each for confirmation. This confirmed value is reported as the CTI in the examples. A 100-drop value was not determined, hence “rapid test method based on” the specified standard.

### Flame Retardancy:

The flame retardancy of the polycarbonate compositions was tested according to Underwriters Laboratories method UL 94 V in thicknesses of 1.5 mm-3 mm. The tested test bars were conditioned beforehand for 7 days at 50% relative humidity and 70° C. ambient temperature.

Various fire classes are assigned depending on the behavior of the test specimens. This includes the time until the flame is extinguished, resistance to dripping, or whether a material produces burning drips. The classes determined hereafter are designated V0, V1 and V2 and are ascertained on the basis of a total of five tested test specimens.

V0: The test specimen, positioned with its longitudinal axis 1800 (vertical) to the flame, has an average afterflame time after removal of the flame of not more than 10 s and does not produce any dripping plastic particles that ignite cotton wool located under the test specimen. The total afterflame time of five test specimens, in each case with two times flame application, is at most 50 s.

V1: In contrast to V0, the average maximum afterflame time here is <30 s, and here too no dripping particles or ignition of the cotton wool are permitted. The total afterflame time of five test specimens, in each case with two times flame application, is <250 s.

V2: In contrast to V0 and V1, dripping plastic particles that ignite the cotton wool are formed in this classification. The individual afterflame times are <30 s and the total afterflame time of 5 test specimens, in each case with two times flame application, is <250 s.

f.: The test does not deliver a flame retardancy classification if the afterflame times are exceeded.

### Heat Distortion Resistance:

The heat distortion resistance of the compositions was determined on the basis of the Vicat softening temperature (method B, test force 50 N, heating rate 50 K/h) on test specimens having the dimensions 80 mm×10 mm×4 mm according to ISO 306:2014-3.

### 2. Production of the Test Specimens

The compositions were prepared on a 25 mm twin-screw extruder from Coperion with a throughput of 20 kg/h. The temperatures of the polymer melt in the extruder were between 260-280° C. with an average screw speed of 225 rpm.

The test specimens having the dimensions 60 mm×40 mm×4 mm were produced from the molding compounds using standard injection molding methods at a melt temperature of 280° C. and a mold temperature of 80° C.

### 3. Results

In the tables below, “n.t.” means “not tested” and “f.” means “failed”. The “*” means “taken from UL Yellow Card”.

TABLE 1
UHMWPE without flame retardant

| Component | | V-1 | V-2 | V-3 | V-4 | V-5 | V-6 |
|---|---|---|---|---|---|---|---|
| A-1 | % by wt. | 100 | 94 | 93 | 92 | 91 | 90 |
| A-2 | % by wt. | | 5 | 5 | 5 | 5 | 5 |
| B-1 | % by wt. | 0 | 1.0 | 2.0 | 3.0 | 4.0 | 5.0 |
| CTI | V | 250 | 200 | 200 | 600 | 600 | 300 |
| UL94 | 1.5 mm, 7 d | V2* | n.t | n.t. | n.t. | n.t. | n.t. |
| | 2 mm, 7 d | V2* | n.t. | n.t. | n.t. | n.t. | n.t |
| | 3 mm, 7 d | n.t. | n.t. | n.t. | n.t. | n.t. | n.t. |
| Vicat | ° C. | 144 | 144 | 144 | 144 | 144 | 143 |
| temperature | | | | | | | |

Note:
V-9 with BDP achieves only UL94-V2, i.e. no better values are to be expected for V-1 to V-6

Table 1 shows compositions consisting of polycarbonate and various contents of ultra-high molecular weight polyethylene (UMWPE). The results of the CTI tests show that the comparative tracking index of polycarbonate can be markedly improved to 600 V by adding 3% and 4% by weight of UHMWPE (examples V-4, V-5). 2.0% by weight or less of PE has if anything a negative, or at best no, influence on the CTI value (V-1, V-2, V-3). It is striking that even larger amounts of PE lead in turn to a poorer CTI value, which clearly shows that there is a certain preferential range for PC/PE compositions, where the PE content must not be too low, but also not too high, in order to attain a CTI of 600 V. However, the following results should also be taken into account here, as the phosphorus-containing flame retardant also has an influence. Within a fairly narrow range, the addition of PE has no negative influence on the Vicat softening temperature of the polycarbonate.

TABLE 2
UHMWPE with flame retardant

| Component | | E-7 | E-8 | V-9 | V-10 | E-11 | E-12 | E-13 | V-14 | V-15 |
|---|---|---|---|---|---|---|---|---|---|---|
| A-1 | % by wt. | 86.4 | 86.9 | 86.4 | 85.9 | 86.5 | 85.4 | 85.9 | 87.4 | 87.9 |
| A-2 | % by wt. | 5 | 5 | 5 | 5 | 5 | 5 | 5 | 5 | 5 |
| E-1 | % by wt. | 0.5 | 0.5 | 0.5 | 0.5 | | 0.5 | 0.5 | 0.5 | 0.5 |
| E-2 | % by wt. | 0.1 | 0.1 | 0.1 | 0.1 | | 0.1 | 0.1 | 0.1 | 0.1 |
| B-1 | % by wt. | 3.0 | 3.0 | 4.0 | 4.0 | 4.0 | 4.0 | 4.0 | 6.0 | 6.0 |
| C-1 | % by wt. | 4.0 | 4.0 | 4.0 | 4.0 | 4.0 | 4.0 | 4.0 | | |
| D-1 | % by wt. | 1.0 | | | 0.5 | 0.5 | 1.0 | | 1.0 | |
| D-2 | % by wt. | | 0.5 | | | | | 0.5 | | 0.5 |
| CTI | V | 600 | 600 | 600 | 600 | 600 | 600 | 600 | 600 | 600 |
| UL94 | 1.5 mm, 7 d | V0 | V1 | V2 | V2 | f. | V1 | V1 | f. | f. |
| | 2 mm, 7 d | V0 | V0 | V2 | V2 | V0 | V0 | V0 | f. | f. |
| | 3 mm, 7 d | V0 | V0 | f. | f. | V0 | V0 | V0 | f. | f. |
| Vicat | ° C. | 128 | 128 | 127 | 128 | 130 | 127 | 128 | 142 | 141 |
| temperature | | | | | | | | | | |

Table 2 shows compositions of polycarbonate with UHMWPE in combination with BDP and PTFE. The results of the individual compositions show the influence of flame retardant and anti-drip agent both on the comparative tracking index and on the fire performance. Surprisingly, the addition of BDP to PC/PE mixtures does not per se lead to a lowering of the CTI. But in each case a combination with PTFE or PTFE/SAN is necessary in order to achieve the desired V0 flame classification according to UL94 (see V-9). When considering the results V-10 and E-13 in comparison, it is striking that the fire performance is somewhat worsened by the addition of mold-release agent, and 0.5% by weight of PTFE/SAN (50:50 mixture), i.e. 0.25% by weight of PTFE, is not sufficient as an anti-drip agent. Contrasting with this is E-13, in the composition of which pure PTFE powder was alternatively added, which leads to a marked improvement in the fire performance. The same applies to E-12, which by calculation likewise contains 0.5% by weight of PTFE (in a 50:50 masterbatch with SAN). It can therefore be concluded that a certain minimum concentration (here 0.5% by weight) of pure PTFE is required.

TABLE 3
Concentration ranges for BDP and further PE

| Component | | E-16 | E-17 | E-18 | V-19 | V-20 | E-21 |
|---|---|---|---|---|---|---|---|
| A-1 | % by wt. | 83.9 | 83.9 | 83.4 | 82.4 | 78.4 | 85.9 |
| A-2 | % by wt. | 5 | 5 | 5 | 5 | 5 | 5 |
| E-1 | % by wt. | 0.5 | 0.5 | 0.5 | 0.5 | 0.5 | 0.5 |
| B-1 | % by wt. | 4.0 | 4.0 | 4.0 | 4.0 | 4.0 | |
| B-2 | % by wt. | | | | | | 4.0 |
| C-1 | % by wt. | 6.0 | 6.0 | 6.0 | 8.0 | 12.0 | 4.0 |
| D-1 | % by wt. | 0.5 | | 1.0 | | | |
| D-2 | % by wt. | | 0.5 | | | | 0.5 |
| CTI | V | 600 | 600 | 600 | 300 | 275 | 600 |
| UL94 | 1.5 mm, 7 d | V1 | V1 | V1 | V2 | V2 | V0 |
| | 2 mm, 7 d | V1 | V0 | V0 | V2 | V2 | V0 |
| | 3 mm, 7 d | V0 | V0 | V0 | f. | V2 | V0 |
| Vicat | ° C. | 119 | 119 | 119 | 115 | 105 | 127 |
| temperature | | | | | | | |

f.: “failed”

Table 3 shows the influence on CTI and flame retardancy when various concentrations of BDP are added. Concentrations ≥8% by weight of BDP (in this respect see also table 2) have a marked negative effect on the CTI and cannot attain UL 94 V0 classification without an ant-drip agent (see V-19, V-20). The combination of 6% by weight of BDP and 0.25% by weight of PTFE (in the masterbatch, E-16) afford the desired high CTI and a V0 classification. In order to ensure a sufficient V0 classification even in the case of relatively thin wall thicknesses, higher PTFE concentrations of 0 0.5% by weight of PTFE (E-17), also in the form of the masterbatch D-1, should be used in combination with 6% by weight of BDP (E5.). Equally as well as with UHMWPE, however, materials with a CTI of 600 V and a V0 classification at 2 mm can also in principle be obtained with HDPE, in combination with BDP and PTFE, (see E-21).

TABLE 4
UHMWPE/PE with phosphazene

| Component | | V-22 | E-23 | E-24 | V-25 | V-26 | E-27 |
|---|---|---|---|---|---|---|---|
| A-1 | % by wt. | 86.4 | 85.4 | 85.9 | 77.4 | 73.4 | 85.9 |
| A-2 | % by wt. | 5 | 5 | 5 | 10 | 10 | 5 |
| E-1 | % by wt. | 0.5 | 0.5 | 0.5 | 0.5 | 0.5 | 0.5 |
| E-2 | % by wt. | 0.1 | 0.1 | 0.1 | 0.1 | 0.1 | 0.1 |
| B-1 | % by wt. | 4.0 | 4.0 | 4.0 | 4.0 | 4.0 | |
| B-2 | % by wt. | | | | | | 4.0 |
| C-2 | % by wt. | 4.0 | 4.0 | 4.0 | 8.0 | 12.0 | 4.0 |
| D-1 | % by wt. | | 1.0 | | | | |
| D-2 | % by wt. | | | 0.5 | | | 0.5 |
| CTI | V | 300 | 600 | 600 | 275 | 225 | 600 |
| UL94 | 1.5 mm, 7 d | V2 | V1 | V1 | V2 | V2 | V0 |
| | 2 mm, 7 d | V2 | V0 | V0 | V2 | V2 | V0 |
| | 3 mm, 7 d | f. | V0 | V0 | V2 | V2 | V0 |
| Vicat | ° C. | 131 | 131 | 132 | 122 | 111 | 132 |
| temperature | | | | | | | |

Table 4 shows the influence on CTI and flame retardancy when various concentrations of phosphazene are added. Comparably to the compositions with BDP, mixtures with relatively high concentrations of phosphazene also have a markedly lower CTI. The values are even lower than those of BDP-additized compositions (see V-25, V-26). It is striking that when using phosphazene, in contrast to BDP, a mixture without PTFE in no cases affords a CTI of 600 V (see V-22). A minimum amount of 0.5% by weight of pure PTFE is required here in order to attain both the CTI and the flame retardancy (V0) (see E-24), with the 50:50 mixture with SAN performing just as well here (E-23). As already shown above, equally good features can be achieved with HDPE instead of UHMWPE (E-27).

TABLE 5
UHMWPE with C4 salt

| Component | | V-28 | V-29 | V-30 |
|---|---|---|---|---|
| A-1 | % by wt. | 90.35 | 90.31 | 85.9 |
| A-2 | % by wt. | 5 | 5 | 5 |
| E-1 | % by wt. | 0.5 | 0.5 | 0.5 |
| E-2 | % by wt. | 0.1 | 0.1 | 0.1 |
| B-1 | % by wt. | 4.0 | 4.0 | 4.0 |
| Cx | % by wt. | 0.05 | 0.09 | 0.05 |
| C-1 | % by wt. | | | 4.0 |
| D-1 | % by wt. | | | 0.5 |
| CTI | V | 600 | 225 | 200 |
| UL94 | 1.5 mm, 7 d | f. | f. | f. |
| | 2 mm, 7 d | f. | f. | V0 |
| | 3 mm, 7 d | V2 | V2 | V0 |
| Vicat temperature | ° C. | 141 | 141 | 128 |

The results in table 5 show that the use of metal sulfonates (C4 salt, Cx) as flame retardants has a markedly greater effect on the comparative tracking index than the addition of BDP. Whereas extremely small concentrations have no negative influence on the CTI (example V-28), concentrations as low as 0.09% by weight entail a drop in the CTI to 225 V (V-29), below the comparative tracking index of pure bisphenol A-based polycarbonate. While the UL 94 V0 classification at 2 mm can be achieved by adding BDP, the CTI value remains at a low level (V-30).

1. A thermoplastic composition, containing
A) at least 70% by weight of aromatic polycarbonate,
B) >2.0% by weight to 6.0% by weight of polyethylene,
C) 2.5% by weight to <8.0% by weight of phosphorus-containing flame retardant,
D) 0.2% by weight to 2.0% by weight of fluorine-containing anti-drip agent,
wherein the composition is free of flame retardants selected from the group of alkali metal, alkaline earth metal or ammonium salts of aliphatic or aromatic sulfonic acid, sulfonamide or sulfonimide derivatives,
and wherein, if the composition contains >4.0% by weight of polyethylene, at least 0.5% by weight of fluorine-containing anti-drip agent is present,
and wherein the % by weight figures are based on the overall composition.

2. The thermoplastic composition as claimed in claim 1, wherein the polyethylene is an HDPE, an HMWPE, a UHMWPE, or a mixture of these.

3. The thermoplastic composition as claimed in claim 1, wherein the phosphorus-containing flame retardant is an organophosphate, a phosphazene or a mixture of these.

4. The thermoplastic composition as claimed in claim 1, wherein, as phosphorus-containing flame retardant, an organophosphate of formula (11) is present 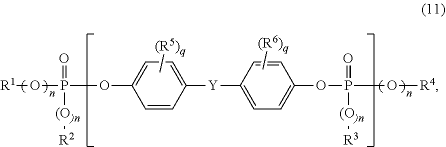
in which
R¹, R², R³ and R⁴ are each independently a linear or branched C₁- to C₈-alkyl radical and/or optionally linear- or branched-alkyl-substituted C₅- to C₆-cycloalkyl radical, C₆- to C₁₀-aryl radical or C₇- to C₁₂-aralkyl radical,
n is independently 0 or 1,
q is independently 0, 1, 2, 3 or 4,
N is a number between 1 and 30,
R₅ and R₆ independently of one another are linear or branched C₁- to C₄-alkyl radical, and
Y is linear or branched C₁- to C₇-alkylidene, a linear or branched C₁- to C₇-alkylene radical, C₅- to C₁₂-cycloalkylene radical, C₅- to C₁₂-cycloalkylidene radical, —O—, —S—, —SO—, SO₂ or —CO—.

5. The thermoplastic composition as claimed in claim 1, wherein, as phosphorus-containing flame retardant, phosphazene of formula (13g) is present 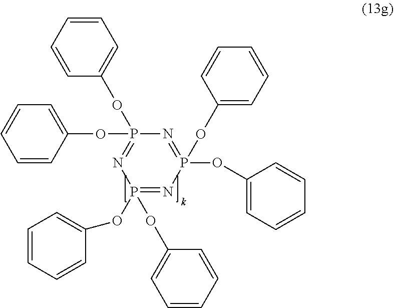
where k=1, 2 or 3, including mixtures thereof.

6. The thermoplastic composition as claimed in claim 1, containing 3% to 6% by weight of phosphorus-containing flame retardant.

7. The thermoplastic composition as claimed in claim 1, wherein mold-release agent is present, as fluorine-containing anti-drip agent PTFE is present, and the amount of PTFE is at least 0.5% by weight.

8. The thermoplastic composition as claimed in claim 1, containing 3% to 4% by weight of polyethylene.

9. The thermoplastic composition as claimed in claim 1, containing up to 1.0% by weight of fluorine-containing anti-drip agent.

10. The thermoplastic composition as claimed in claim 1, consisting of
A) at least 70% by weight of aromatic polycarbonate,
B) >2.0% by weight to 6.0% by weight of polyethylene,
C) 2.5% by weight to <8.0% by weight of phosphorus-containing flame retardant,
D) 0.2% by weight to 2.0% by weight of fluorine-containing anti-drip agent, wherein, if the composition contains >4.0% by weight of polyethylene, at least 0.5% by weight of fluorine-containing anti-drip agent is present, and
E) 0% to 5% by weight of one or more further additive(s), selected from the group consisting of heat stabilizers, antioxidants, mold-release agents, UV absorbers, IR absorbers, antistats, flame retardants different from component C, excluding alkali metal, alkaline earth metal or ammonium salts of aliphatic or aromatic sulfonic acid, sulfonamide or sulfonimide derivatives, optical brighteners, light-scattering agents, hydrolysis stabilizers, transesterification stabilizers, organic dyes, organic pigments, inorganic pigments, compatibilizers, flow improvers, additives for laser marking, and mixtures thereof.

11. A molding consisting of, or comprising a region made from, a thermoplastic composition as claimed in claim 1.

12. The molding as claimed in claim 11, wherein the molding is part of a high-voltage switch, inverter, relay, electronic connector, electrical connector, circuit breaker, a photovoltaic system, an electric motor, a heat sink, a charger or charging plug for electric vehicles, an electrical junction box, a smart meter housing, a miniature circuit breaker, or a busbar.

13. A method for attaining a CTI of 600 V and a UL94 V0 classification at 3 mm in a thermoplastic composition containing at least 70% by weight of aromatic polycarbonate comprising providing a thermoplastic compostions comprising >2.0% by weight to 6.0% by weight of polyethylene, 2.5% to <8.0% by weight of phosphorus-containing flame retardant and 0.2% to 2.0% by weight of fluorine-containing anti-drip agent, wherein, if the composition contains >4.0% by weight of polyethylene, at least 0.5% by weight of fluorine-containing anti-drip agent is present, and wherein the % by weight figures are based on the resulting overall composition.

14. An EE component, comprising
a first electrical conductor and a second electrical conductor at a first distance d1 and a second distance d2 with respect to one another,
which are connected via a thermoplastic composition as claimed in claim 1, which is in direct contact with the first electrical conductor and the second electrical conductor,
wherein the distance d1 is the shortest distance between the first electrical conductor and the second electrical conductor along the surface of the thermoplastic composition and
wherein the distance d2 is the shortest distance between the first electrical conductor and the second electrical conductor through the air,
wherein d2 is selected in such a way that at the respective operating voltage a sparkover through the air is prevented and
wherein d1, at the operating voltage U listed below, is:
d1i(0 V≤U≤250 V): 1.3 mm to <2.5 mm
d1ii(250 V<U≤500 V)=2.5 mm to <5.0 mm
d1iii(500 V<U≤1000 V)=5.0 mm to <10.0 mm.

15. The thermoplastic composition as claimed in claim 1, wherein the aromatic polycarbonate is bisphenol A-based homopolycarbonate.
